(19) United States
(12) Patent Application Publication
(10) Pub. No.: US 2008/0008037 A1
(43) Pub. Date: Jan. 10, 2008

(54) ACOUSTIC PROPAGATION VELOCITY MODELING METHODS, APPARATUS AND SYSTEMS

(76) Inventor: KENNETH E. WELKER, Nesoya (NO)

Correspondence Address: WESTERNGECO L.L.C., PO BOX 2469, HOUSTON, TX, 77252-2469, US

(21) Appl. No.: 11/456,148

(22) Filed: Jul. 7, 2006

(51) Int. Cl. G01V 1/38

(52) U.S. Cl. 367/21

(57) ABSTRACT

Methods, apparatus, and systems for accurately estimating acoustic propagation velocity are described. One method comprises deploying in a marine environment a towed seismic spread comprising a plurality of acoustic positioning transmitters and a plurality of positioning point receivers, and using travel times for signals between at least some of the transmitters and point receivers to derive a mathematical model describing acoustic propagation velocity for the marine environment as a function of at least one spread spatial dimension, distances between transmitters and receivers, and any combination thereof. This abstract is provided to comply with the rules requiring an abstract, and allows a reader to quickly ascertain the subject matter of the technical disclosure. It is submitted with the understanding that it will not be used to interpret or limit the scope or meaning of the claims.

### BACKGROUND OF THE INVENTION

1. Field of Invention

The present invention relates generally to the field of marine seismic methods and equipment used in marine seismic exploration, and more specifically to methods and systems for more accurately estimating acoustic propagation velocity in marine environments in a cost effective manner.

2. Related Art

Marine seismic exploration investigates and maps the structure and character of subsurface geological formations underlying a body of water. In so-called seabed seismic, a cable containing seismic receivers is deployed onto the seabed from a surface vessel. In towed marine seismic surveys, one or more towed streamer cables and towed acoustic sources are deployed behind one or more vessels in a fleet. The seismic operators need accurate position determination of the receivers, and the typically used method for positioning is based on underwater acoustic ranging. Typically in 3-dimensional, 4-dimensional, and over/under towed marine seismic surveys, streamer spreads employ acoustic distance measurements to determine the positions of the seismic receivers in the streamers. Hydrophone receiver positioning may be achieved by a full acoustic network (sometimes referred to as IRMA—intrinsic range modulated acoustics) independent of streamer length. The hydrophones also act as receivers for the positioning signal. Unlike conventional systems in which the accuracy of the hydrophone locations degrades between acoustic positioning nodes, Q-Marine technology delivers consistent accuracy down the full length of the streamers. This improved receiver positioning accuracy translates into improved retention of high frequencies in the seismic dataset. And higher frequencies translate into improved vertical and lateral resolution. A survey vessel known as a Q-Technology™ vessel may conduct seismic surveys towing multiple, 1000-10,0000-meter cables with a separation of 25-50 meters, using the WesternGeco proprietary calibrated Q-Marine™ source. “Q” is the WesternGeco proprietary suite of advanced seismic technologies for enhanced reservoir location, description, and management.

Receiver coordinate estimation most often employs marine acoustic signal travel times for some part of the estimation algorithm. In order to translate the marine acoustic signal travel times to distance, the marine acoustic propagation velocity is required. The value used for this translation is often the result of a measurement of the marine variables salinity, temperature and pressure. These variables are used in any one of the most widely accepted sound velocity formulas.

There are at least two methods to measure salinity, temperature and pressure. One is to use a retrievable or disposable sound velocity probe. These generally measure conductivity (salinity), temperature and pressure at fixed intervals during their descent through the water column. These measured values, having been either stored or communicated back to the vessel, are then used in the sound velocity formula.

Alternatively, sound velocimeters can be deployed along streamers. These devices work on at least two principles. They can measure conductivity (salinity), temperature and pressure to be used in a sound velocity formula or they can emit an acoustic pulse locally and record it on the other end of the device, a fixed known length. The travel time over a known length gives the sound velocity.

In addition to the above measurement mechanisms, estimation of a scale factor can give a best-fit value that will cause the measurements to fit together in some optimal way depending on the optimizing criteria, least squares for example. Given a precisely-known location for one of the members of an acoustic transmitter/receiver pair and an accurate measure of the wavefield traveltime between the members of the pair, the range between the two can be calculated if the propagation velocity characteristic of the material along the wavefield trajectory (travel path) is known or can be determined. From several such ranges, the location of the imperfectly-located member of the pair can be defined by multi-lateration (sometimes incorrectly referred to as triangulation). If the locations of both members of the pair are uncertain, certain well-known statistical filtering methods, such as Kalman filtering, are available.

There are shortcomings to all the above methods of obtaining a propagation model estimate. In the case of the measurement approach, if a sound velocity probe travels vertically through the water column, it gives only a point measurement for each horizontal plane. Thus if there is a horizontal sound velocity gradient, the measurement is erroneous for the spread extent. One might consider simply measuring more points, but this is operationally prohibitive as the cost of the measurement operation is high in terms of equipment, boat time, and may further present health, safety or environmental risks.

Measurements along the streamer appear to solve this problem by giving the sound velocity in the plane or volume where the acoustic measures originate and are recorded again. Unfortunately, this is not practically adequate since the acoustic signal often does not propagate in a plane. Rather, the vertical sound velocity profile is frequently such that acoustic energy rays are refracted away from the plane, sometimes reflecting against a strong density interface such as the air water surface or ocean bottom surface, and sometimes bending in a non straight bow shape between source and receiver. Further, the refraction can be different over the horizontal extent of the streamer spread so that modeling the acoustic energy propagation paths (ray tracing) requires numerous horizontal and vertical measurement points.

Thus due to refraction, the basic assumption that sound velocity at any point can be used to translate travel time to space is flawed, yet prevalent throughout the seismic navigation community. The method of scale estimation is a better alternative than using many local measurements of sound velocity. The scale estimation method attempts to fit all ranges together according to optimal criteria like least squares. Yet the model for a single scale estimate is that one scale value applies across the entire extent of the spread, which is not optimal, since single scale estimation smears out errors for ranges with different propagation velocities in an optimum sense but there remains residual error in some cases that are not normally distributed due to the error in the single scale model.

From the above it is evident that there is a need in the art for improvement in estimating marine acoustic propagation velocity.

### SUMMARY OF THE INVENTION

In accordance with the present invention, methods, apparatus, and systems are described to estimate acoustic propagation velocity for acoustic signals in a towed marine seismic acquisition spread by deriving a mathematical model comprising one or more mathematical functions, such as a polynomial in 2- or 3-dimensions, to acoustic travel time measurements that may be part of the towed marine seismic acquisition spread. Methods, apparatus, and systems of the invention may be used to collect marine seismic data, for example 3-D and 4-D marine seismic data. Acoustic networks comprising spatially frequent acoustic transmitters and receivers greatly overdetermined with degrees of freedom may be used to estimate amplitude coefficients of even high order polynomials. The measured travel times between acoustic source and receiver points are the adjustment observations, together with GPS control points and additional information, including, but not limited to, streamer and non-streamer cable lengths, nominal distance between acoustic positioning receivers on a streamer, and the like. Since the acoustic propagation velocity varies with horizontal separation between source and receiver, this is another component that may be included in the estimation model to give better precision to the estimation.

A first aspect of the invention are methods of obtaining a substantially accurate estimate of the absolute or real position of receivers in one or more streamers of a towed marine seismic spread, one method comprising:
a) deploying in a marine environment a towed seismic spread comprising a plurality of acoustic positioning transmitters and a plurality of positioning point receivers; and
b) using travel times of at least some signals between the transmitters and point receivers to derive a mathematical model describing acoustic propagation velocity for the marine environment as a function of at least one spread spatial dimension, distance between transmitters and receivers, and any combination of these.

A separate polynomial for several distance values may be used, or a continuous function. For example, a continuous linear function describing sound velocity may be the following:
sv=mx+ny+pz+const
where
“sv” is sound velocity;
“mx+ny” describes the spatial dependence in x and y;
“pz” describes the range length dependency;
“m”, “n”, and “p” are amplitude coefficients; and
“const” is the combined intercept value for the three linear terms.

The estimation of the acoustic propagation velocity (sound velocity), and transmitter and/or receiver coordinates along with the unknown amplitude coefficients of mathematic functions may occur in one step. For example, a set of linear equations may be inverted simultaneously, giving an estimate of both the coordinates and amplitude coefficients, until an arbitrary convergence limit is reached.

Alternatively, an iterative method may be used. Methods within this aspect of the invention include those comprising using the acoustic propagation model to iteratively determine position of the point receivers. Other methods within the invention comprise those wherein the acoustic positioning transmitters each generate different orthogonally encoded spread spectrum signals, and the derivation of the acoustic propagation velocity model comprises transmitting these signals from the plurality of transmitters. The spread spectrum signals may each have a prominent peak in an autocorrelation function thereof. The method may further comprise detecting the spread spectrum signals using a plurality of acoustic point receivers positioned at nominal or provisional locations, the point receivers being in communication with a calculation unit. Nominal or provisional distances may be defined between each of the plurality of acoustic positioning transmitters and every point positioning receiver. Certain methods include measuring one or more sets of times for reception of a first set of spread spectrum signals at the positioning receivers for each set of nominal or provisional distances, and with the aid of a calculation unit, nominal acoustic propagation velocity may be calculated as a function of the nominal or provisional distances, the time for reception of the signals, and at least one coordinate of the point receivers, and this procedure iterated until suitable closure is obtained. As used herein “nominal” is used to describe the spread distance relations with no forces on the spread elements. “Provisional” is a word often used in estimation theory that means the best estimate for the first adjustment cycle. The outcome of the first adjustment cycle is the input or provisional value for the next adjustment cycle. A provisional value may be any type of value, distance, direction, temperature, anything being estimated. Range is a measured distance but a nominal distance is an ideal distance. For example, the nominal length is 10 kms, made up of 100, 100 meter sections. A range measurement along the length of the streamer might provide 10,010 meters, 10 meters longer due to stretch on the streamer due to towing tension.

Apparatus of the invention comprise:
(a) a towed streamer marine seismic spread comprising a plurality of acoustic positioning transmitters and a plurality of acoustic positioning receivers, the transmitter and receivers adapted to communicate with a calculation unit;
(b) the calculation unit adapted to derive an acoustic propagation velocity model wherein acoustic propagation velocity is a function of at least one spatial dimension of the spread, distances between transmitters and receivers, and any combination of these.

Apparatus of the invention include those wherein all acoustic positioning transmitters are non-encoded acoustic positioning transmitters, apparatus wherein all the transmitters are orthogonally encoded signal sequence acoustic positioning transmitters, and apparatus wherein some of the transmitters are encoded and others are not. The acoustic positioning transmitters may be “transceivers”, units able to both transmit and receive acoustic signals, as are known in the art. The calculation unit may estimate the transmitter and/or receiver coordinates along with the unknown amplitude coefficients of mathematic functions in one step. For example, a set of linear equations may be inverted simultaneously, giving an estimate of both the coordinates and amplitude coefficients, until an arbitrary convergence limit is reached. Alternatively, the calculation unit may iteratively calculate sets of time measurements for one or more sets of nominal or provisional distances into nominal or provisional acoustic propagation velocities, and use the nominal or provisional acoustic propagation velocities and subsequently measured reception times for successive acoustic pulses from the transmitters to reach the point receivers to estimate ranges, the time measurements being for orthogonally encoded acoustic signals to travel through water of unknown temperature, pressure, and salinity from the transmitters to the receivers.

Systems of the invention comprise:
(a) a tow vessel; and
(b) an apparatus of the invention.

Methods, apparatus and systems within the invention include those wherein the any measurement of acoustic energy travel time, measured by any pair of devices (transmitter, receiver, or transceiver), mounted on any spread element, (vessel, autonomous under water vehicle [auv], source array, supply vessel, work boat, streamer front or tail float) or streamer may be used. An acoustic propagation velocity function may be derived by iteratively fitting or fitting in a single step one or more mathematical functions to a set of data comprising ranges, reception times, and coordinates either in a selected portion of the spread or the entire spread. The reception times in the set of data comprises measured times between transmission and reception at each receiver of acoustic signals from each of the acoustic transmitters. Optionally, the Z coordinate (depth) may also be a variable in acoustic velocity functions useful in the invention. The mathematical function may be a set of linear equations, and may be selected from simple and smooth functions, such as polynomials. In mathematics, polynomial functions, or polynomials, are an important class of simple and smooth functions. As used herein, “simple” means they are constructed using only multiplication and addition (including division and substraction). “Smooth” means they are infinitely differentiable, i.e., they have derivatives of all finite orders. Methods, apparatus, and systems of the invention include those wherein the mathematical function is 2- or 3-dimensional function, and those wherein variation of the acoustic propagation velocity with horizontal separation distance between transmitters and receivers is accounted for in the estimate. Because of their simple structure, polynomials are relatively easy to evaluate, and are used extensively in numerical analysis for polynomial interpolation or to numerically integrate more complex functions. With the advent of computers, polynomials have in some instances been replaced by “splines” in many areas in numerical analysis. As used herein “splines” are piecewise defined polynomials and may provide more flexibility than ordinary polynomials when defining simple and smooth functions.

Methods, apparatus and systems of the invention include those wherein the mathematical function is a polynomial, and the polynomial is selected from polynomial functions of degree ranging from 1 to 10 or higher. Polynomial functions of degree 0 are called constant functions (excluding the zero polynomial, which has indeterminate degree), degree 1 are called linear functions, degree 2 are called quadratic functions, degree 3 are called cubic functions, degree 4 are called quartic functions and degree 5 are called quintic functions.

If a polynomial function is used, the coefficients of the polynomial may be determined by any of a number of algorithms; which algorithm is used for a given polynomial may depend on the form of the polynomial and the chosen variable. To evaluate a polynomial in monomial form one may use the Homer scheme. For a polynomial in Chebyshev form the Clenshaw algorithm may be used. If several equidistant xₙ have to be calculated, Newton's difference method may be used. Quotients of polynomials are called rational functions, and these may be used in methods, apparatus, and systems of the invention, as may so-called piecewise rationals. Other functions, if required, may be utilized through suitable software, including trigonometric functions, logarithms and exponential functions.

As there is no general closed formula to calculate the roots of a polynomial of degree 5 and higher, root-finding algorithms are used in numerical analysis to approximate the roots. Approximations for the real roots of a given polynomial can be found using Newton's method, or more efficiently using Laguerre's method which employs complex arithmetic and can locate all complex roots. These methods are known to mathematicians.

The mathematical function may be a multivariate function, such as a multivariate polynomial (a polynomial having several variables). In multivariate calculus, polynomials in several variables play an important role. These are the simplest multivariate functions and can be defined using addition and multiplication alone.

The transmitters may be adapted to generate spread spectrum signals at any frequency. In certain applications this frequency may range from about 500 to about 4000 Hz. The signals may or may not be transmitted in response to a given command, which need not be scheduled at any given time; indeed they may be randomly transmitted. The transmitters may be controlled to deliver their spread spectrum signals in synchronized fashion relative to a given seismic event, and different orthogonal codes may be used for individual spread spectrum signals. The transmitters may be conventional underwater audio-acoustic transmitters. The principal requirement of the transmitters is that they should be capable of transmitting a signal which is sufficiently strong to be able to be received several kilometers from the transmitter and that the signals or codes which are transmitted also contain frequency components which lie within the frequency band which the receivers (hydrophones) are capable of detecting. The further apart the transmitters are placed the better the positioning resolution which is obtained.

Yet another method of the invention is a method of using the estimated ranges between transmitters and receivers to acquire more accurate marine seismic data, or correct previously acquired data.

The apparatus, systems and methods of the invention, as well as other aspects of the invention, will become more apparent upon review of the brief description of the drawings, the detailed description of the invention, and the claims that follow.

### BRIEF DESCRIPTION OF THE DRAWINGS

The manner in which the objectives of the invention and other desirable characteristics can be obtained is explained in the following description and attached drawings in which:

FIG. 1 is a schematic illustration of a towed marine seismic spread employing an apparatus, system, and method of the invention;

FIG. 2 is a computerized representation of the spread, illustrating numerous ranges between transmitters and receivers;

FIG. 3 is a schematic illustration showing how acoustic signals are refracted by water of varying temperature, pressure, and/or salinity; and

FIG. 4 is a schematic illustration of how an acoustic velocity function may be derived and used in methods, apparatus, and systems of the invention.

It is to be noted, however, that the appended drawings are not to scale and illustrate only typical embodiments of this invention, and are therefore not to be considered limiting of its scope, for the invention may admit to other equally effective embodiments.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

All phrases, derivations, collocations and multiword expressions used herein, in particular in the claims that follow, are expressly not limited to nouns and verbs. It is apparent that meanings are not just expressed by nouns and verbs or single words. Languages use a variety of ways to express content. The existence of inventive concepts and the ways in which these are expressed varies in language-cultures. For example, many lexicalized compounds in Germanic languages are often expressed as adjective-noun combinations, noun-preposition-noun combinations or derivations in Romanic languages. The possibility to include phrases, derivations and collocations in the claims is essential for high-quality patents, making it possible to reduce expressions to their conceptual content, and all possible conceptual combinations of words that are compatible with such content (either within a language or across languages) are intended to be included in the used phrases.

The methods, apparatus, and systems of the invention estimate positions of towed marine seismic components by use of a more precise and cost effective acoustic propagation model than previous methods. The conventional ways of obtaining an acoustic propagation model estimate either give imprecise ranges, are too costly, or both. In the case of the measurement approach, simply measuring more points may be operationally prohibitive in terms of cost, vessel time, health, safety and/or environmental risks. Measurements along the streamer appear to solve this problem by giving the sound velocity in the plane or volume where the acoustic measures originate and are recorded again. Unfortunately, this is not practically adequate due to refraction. The method of scale estimation is a better alternative than using many local measurements of sound velocity, yet the model for a single scale estimate is that one scale value applies across the entire extent of the spread, which is not optimal, since single scale estimation smears out errors for ranges with different propagation velocities in an optimum sense but there remains residual error in some cases that are not normally distributed due to the error in the single scale model. The inventive methods, apparatus, and systems address these problems.

Methods, apparatus, and systems of the invention take advantage of the greatly overdetermined, highly redundant features of intrinsic acoustic ranging by modulated acoustic systems, and use the multitude of time versus range data from such systems to precisely fit high order mathematical functions to the data. While mathematical function fitting of data is known in the seismic industry, the use of such highly redundant data has not heretofore been possible or contemplated in the estimation of marine acoustic propagation velocity.

While the focus of the following mathematical background discussion is on polynomials (see Wikipedia, the free encyclopedia, at http://en.wikipedia.org/wiki/Polynomial), the invention is not limited to use of polynomials for mathematical curve fitting. Because of their simple structure, polynomials may be relatively easy to evaluate, and may be used in numerical analysis for polynomial interpolation or to numerically integrate more complex functions. With the advent of computers, polynomials have in some instances been replaced by splines in many areas in numerical analysis. Splines are piecewise defined polynomials and may provide more flexibility than ordinary polynomials when defining simple and smooth functions.

Given constants (i.e., numbers) a₀, . . . , aₙ in some field (possibly but not limited to real or complex numbers fields) with aₙ non-zero, for n>0, then a polynomial (function) of degree n is a function of the form:
f(x)=a₀+a₁x+ . . . +aₙ₋₁xⁿ⁻¹+aₙxⁿ.
More concisely, the polynomial can be written in sigma notation as:

$$f ( x ) = {\sum }_{i = 0}^{n} {a}_{i} {x}^{i} .$$

The constants a₀, . . . , aₙ are called the coefficients of the polynomial. a₀ is called the constant coefficient and aₙ is called the leading coefficient. When the leading coefficient is 1, the polynomial is called monic or normed. Each summand aᵢ xⁱ of the polynomial is called a term. A polynomial with one, two or three terms is called monomial, binomial or trinomial respectively. Polynomial functions of degree 0 are called constant functions (excluding the zero polynomial, which has indeterminate degree), degree 1 are called linear functions, degree 2 are called quadratic functions, degree 3 are called cubic functions, degree 4 are called quartic functions and degree 5 are called quintic functions.

One important aspect of calculus is the project of analyzing complicated functions by means of approximating them with polynomials. The culmination of these efforts is Taylor's theorem, which roughly states that every differentiable function locally looks like a polynomial, and the Stone-Weierstrass theorem, which states that every continuous function defined on a compact interval of the real axis can be approximated on the whole interval as closely as desired by a polynomial. Polynomials are also frequently used to interpolate functions. Quotients of polynomials are called rational functions. Piecewise rationals are the only functions that can be evaluated directly on a computer, since typically only the operations of addition, multiplication, division and comparison are implemented in hardware. All the other functions that computers need to evaluate, such as trigonometric functions, logarithms and exponential functions, must then be approximated in software by suitable piecewise rational functions. The fast and numerically stable evaluation of a polynomial for a given x is a very important topic in numerical analysis. Several different algorithms have been developed for this problem. Which algorithm is used for a given polynomial depends on the form of the polynomial and the chosen x. To evaluate a polynomial in monomial form one can use the Homer scheme. For a polynomial in Chebyshev form the Clenshaw algorithm can be used. If several equidistant xₙ have to be calculated one might use Newton's difference method.

As there is no general closed formula to calculate the roots of a polynomial of degree 5 and higher, root-finding algorithms are used in numerical analysis to approximate the roots. Approximations for the real roots of a given polynomial can be found using Newton's method, or more efficiently using Laguerre's method which employs complex arithmetic and can locate all complex roots.

In multivariate calculus, polynomials in several variables play an important role. These are the simplest multivariate functions and can be defined using addition and multiplication alone. An example of a polynomial in the variables x, y, and z is
f(x, y, z)=4x²y²−10.45z²+67x³z.
The total degree of such a multivariate polynomial is determined by adding the exponents of the variables in every term, and taking the maximum. The above polynomial f(x, y, z) has total degree 4.

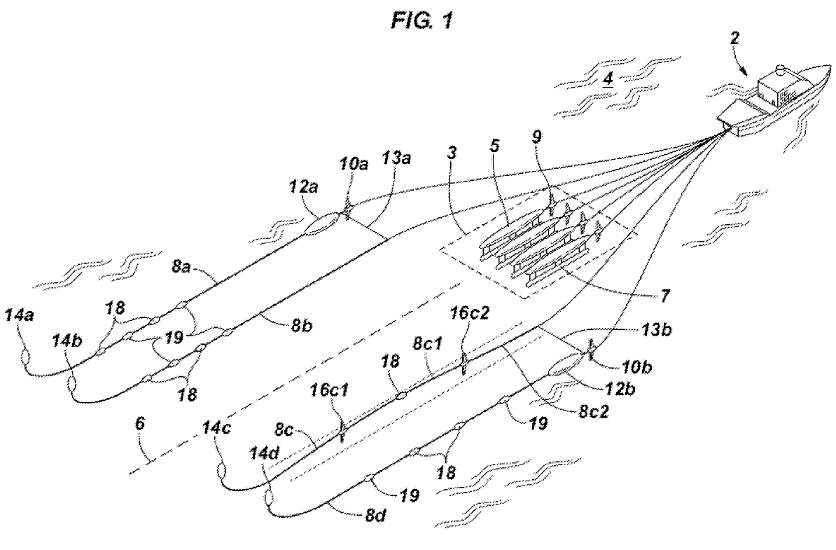

Referring now to the figures, FIG. 1 is a schematic perspective view, not to scale, illustrating some of the principle features of certain methods, apparatus and systems of the invention. Illustrated is a vessel 2 in an ocean or other body of water 4 following generally a desired path, 6. Vessel 2 tows, in this illustrative embodiment, a marine seismic source 3 comprised of floats 5 (four are depicted), each having one or more air-guns 7 or other acoustic signaling devices suspended downwardly therefrom. The details of source 3, floats 5, and air-guns 7 are not important to the inventive methods, apparatus, and systems, and are not further described as they are well-known in the art. Vessel 2 also tows four streamer cables 8a, 8b, 8c, and 8d, each submerged beneath the surface at a certain depth. Each streamer may include a variety of seismic sensors, as well as steering devices attached thereto, or positioned in-line therein. Steering devices may be active or passive. For example, depicted in FIG. 1 are submerged streamer deflectors 10a and 10b on the outer most streamers, 8a and 8d, respectively. Deflectors 10a and 10b may have floatation units 12a and 12b, respectively, floating on the surface. In some designs these floats may not be necessary. Similarly, each source float may have a source deflector 9. Outer-most streamers 8a and 8d may pull their neighboring streamers 8b and 8c, respectively away from centerline using so-called separation ropes or cables 13a and 13b. Each streamer may have a terminal buoy as illustrated at 14a, 14b, 14c, and 14d. Completing FIG. 1 are streamer control devices 16c1 and 16c2, which may be steerable birds, such as those known under the trade designation Q-FIN™, although other designs may work as well.

A plurality of pressure sensitive seismic point receivers (commonly referred to as hydrophones) 18 are provided inside or along the streamer. In FIG. 1 only one is depicted, exaggerated in size. The source-streamer tow vessel and streamers may be part of a system known under the trade designation Q-Marine™, from WesternGeco LLC, Houston, Tex. In these systems, streamers may be equipped with acoustic transmitters and point receivers for accurate position determination, employing intrinsic ranging modulated acoustics, as taught in U.S. Pat. No. 5,668,775, incorporated by reference herein in its entirety. As taught in the 775 patent, the streamer transmitters and point receivers may form a full-streamer-length acoustic network, wherein a unique spread spectrum code of acoustic frequencies are emitted by each of a plurality of acoustic transmitters placed within the streamers, all frequencies being within the seismic frequencies detected by the same receivers during shooting and recording, and the point receivers within the streamers are able to distinguish each transmitter's unique code. Thus, accurate positioning of seismic receivers is possible. Conventional streamers use arrays of hydrophones, such as 12 or 18 hydrophones per group, which are summed together in analog fashion and than recorded. Systems known as Q-Marine™ use single sensors or point receivers: these are placed in the streamer at intervals, for example one every 3 to 4 m, and recorded. All point receivers route data to a computer or other data processing unit, where digital filters are applied taking advantage of the very fine sampling of the receivers for very powerful coherent noise attenuation of line swell noise and/or streamer cable noise. A typical area for pressure stress within which the hydrophones operate, also called seismic band or seismic width, is from 3 Hz to half of the sampling frequency, or from 0 to 500 Hz. The signals intercepted are transmitted via the streamer's system of transmission lines inside the streamers to a receiver station on board vessel 2, or some other location. The point receivers record the seismic signal, but they can also record any signal which lies within the receivers' frequency range. In a marine seismic tow, transmitters 19 are deployed at intervals of approximately 200 meters. Transmitters 19 may be conventional underwater audioacoustic transmitters. The principal requirement of the transmitters is that they should be capable of transmitting a signal which is sufficiently strong to be able to be received several hundred meters from the transmitter and that the signals or codes which are transmitted also contain frequency components which lie within the frequency band, which the hydrophones are capable of detecting. The closer together the transmitters are placed the better the resolution which is obtained. In FIG. 1 the transmitters are shown built into the streamer, i.e. they are located on the inside of streamers 8. The transmitters can also be suspended from streamers. Built-in transmitters may receive far better protection. It is also possible to provide the transmitters on buoys, vessels or ROV's (Remotely Operated Vehicle) which are subsea vehicles.

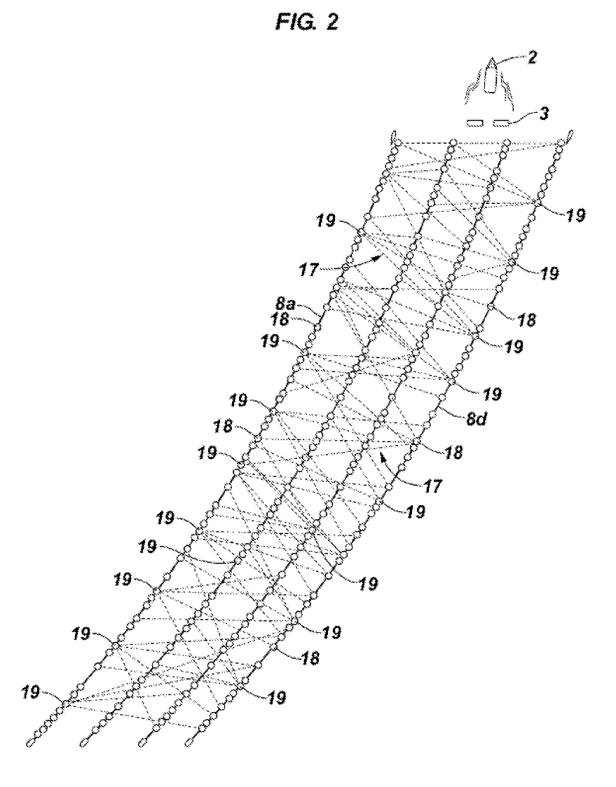

FIG. 2 is a computerized rendition of the marine seismic spread of FIG. 1. Transmitters 19 may transmit spread spectrum signals which are unique acoustic signals which lie within a frequency band that the point receivers (hydrophones) are capable of detecting. The signals are intercepted by the seismic point receivers 18 which are already located in or on streamers 8, or in the gun array cables. Transmitters 19 may transmit a signal on command. Receivers 18 (only a few are noted in FIG. 2 for clarity) will intercept the signals and transmit them on board vessel 2 for processing and storing. There is no rule governing when the signals from the transmitters should be recorded and this can be done during the normal recording time for a shot or also between each shotpoint. Seismic signals may be recorded and stored during a period of 4 to 12 seconds after a shot has been fired. The signals from transmitters 19 may be recorded when wished, since there is no correlation between the seismic signal and the spread spectrum codes, i.e. it is not possible to confuse a seismic signal with a spread spectrum signal transmitted from a transmitter. Had a transmitter been used which transmitted signals on a specific frequency, this would cause them to be confused with seismic signals on the same frequency. Due to the signal-to-noise ratio one procedure may be to record the signals once per shot, and then record the measurement towards the end of the recording time when the seismic signal is weakest, or between the shotpoints.

The signals that are transmitted from transmitters 19 in accordance with the present invention may be so-called orthogonal spread spectrum signals. Spread spectrum techniques are described in the literature and well known by those skilled in the art. An ordinary modulation technique is based on the fact that the transmitted signal uses a certain part of the frequency band in a communication channel, e.g. by means of frequency modulation (FM) or amplitude modulation (AM). As distinct from this, in spread spectrum modulation the entire bandwidth in a communication channel will be used and split up a transmitted signal frequency, the individual parts being transferred on several different frequencies. Only the receivers will know which frequency and phase combination the incoming information will have. The receivers know a transmitter's individual code. By cross-correlating the incoming signals (y(n)) with a transmitter's individual code (x(n)), a receiver will be able to extract the unambiguous spread spectrum signal from the range of other signals. An n=t_{∞} cross-correlation function will be in the form:

$${r}_{xy} ( τ ) = {\sum }_{n = - ∞}^{n = + ∞} y ( n - τ ) \cdot x ( n ) .$$

When a sequence is cross-correlated with itself the process is called auto correlation.

The autocorrelation function of a series x(n) will always have a certain top value for τ=0. It is desirable for spread spectrum sequences which are used for positioning of seismic equipment to have an autocorrelation function which represents a “white noise” pattern apart from τ=0. In order to avoid false detection of, e.g., signals that are recorded by the same receiver use the same communication line, the cross-correlation function between the codes must have a top value that is as low as possible, which is the definition of orthogonal.

The transmission pulse may comprise a set of orthogonal pulses with an unambiguous top in their respective autocorrelation functions. Several conventional methods of generating such functions can be mentioned. Perhaps the most common method uses random sequence codes called Gold codes. This method provides a selection of codes that give low values in the cross-correlation function. These are generated by the use of shift registers of variable length with a special feedback pattern.

There are several methods for generating pseudorandom sequences, e.g. frequency hopping, frequency shift coding or phase coding. Regardless of which pseudorandom sequence is chosen, if encoded signals are used it is important for its autocorrelation function to have a distinct top value and for the cross-correlation to be as low as possible. Even with signal amplitudes down towards the signal amplitude for sea noise it will be possible to extract a correlation's top.

Even calculation of positions for the seismic equipment or the point receivers can be performed in countless different and conventional ways depending on which parameters are known for the system and how the system is configured. The common feature of all methods when using encoded signals, however, is that the received signals have to be cross-correlated with the transmitting signal signature of the specific transmitters to which the absolute or relative distance is being estimated. Further processing of data is performed as described herein. Furthermore, other methods of the invention do not depend at all on use of encoded signals.

The simplest case of using encoded signals comprises a transmitter and a receiver where the system is designed in such a manner that accurate information is available as to when the transmitter transmits in relation to the receivers sampling points. After the above-mentioned cross-correlation a maximum value will be found in the cross-correlation function that indicates the absolute time difference between transmitter and receiver. It will then be possible to develop this technique used on a streamer with several receivers in order to obtain an unambiguous geometrical network of distances and relative positions.

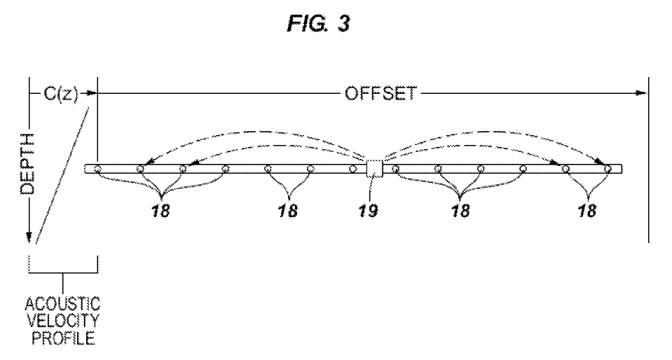

In operation, the inventive methods, apparatus, and systems may process time data to translate times to estimated ranges. Acoustic wavefields (either encoded or uncoded) are launched from each of the respective transmitters 19 and received by point receivers 18 after each launching. Possible ray paths for the direct-path wavefield components are shown in FIG. 2 by dashed lines such as 17. Refracted ray paths, such as those depicted in FIG. 3, are not evident in FIG. 2, however, they are present due to variations in temperature, pressure, salinity of the water, as well as due to the air-water interface. The ray paths associated with reflected arrivals, not being germane to the invention, are not shown.

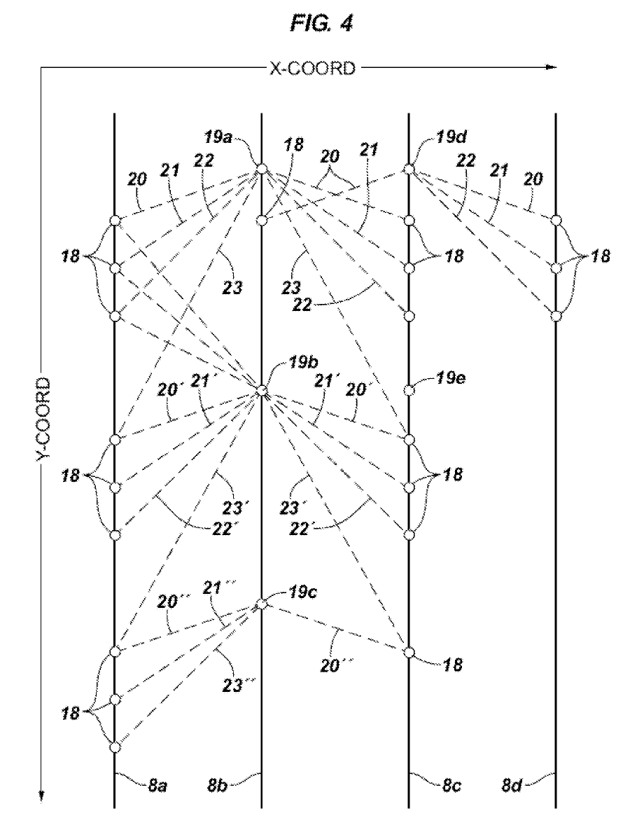

FIG. 4 illustrates how a mathematical function may be derived which fits the time vs. estimated range curve or curves for a four streamer spread. Acoustic transmitters 19a, 19b, 19c, 19d, and 19e are shown, however the majority are not illustrated for clarity. Numerous acoustic point receivers 18 are illustrated in FIG. 4. Importantly, ranges 20, 21, 22, and 23 are shown as dashed lines between transmitter 19a and different ones of point receivers 18 in streamers 8a and 8c. Similarly, ranges 20′, 21′, 22′, and 23′ are shown as dashed lines between transmitter 19b and different other ones of point receivers 18 in streamers 8a and 8c, and ranges 20″, 21″, and 22″ are shown as dashed lines between transmitter 19c and different other ones of point receivers 18. Ranges indicated with dashed lines between transmitter 19d and different ones of receivers 18 in streamers 8b and 8d are also designated 20, 21, and 22, since they are in roughly the same Y-coordinate position, although at different X-coordinate positions in the spread. If desired they could be identified separately as ranges 20a, 21a, 22a to indicate different X— and Y-coordinate positions.

As is known, acoustic propagation velocity may differ at different X-coordinates, different Y-coordinates, and different X-Y coordinates, as well as different Z coordinates. However, it has not been recognized until the present invention that acoustic propagation velocity varies with range between transmitter and receiver. The ranges indicated in FIG. 4 may be grouped into 100 m ranges, such as the ranges indicated at 20, 20′, 20″ and the like; 200 m ranges, such as the ranges indicated at 21, 21′, 21″, and the like; 300 m ranges, such as the ranges indicated at 22, 22′, 22″, and the like; 400 m ranges, such as indicated at 23, 23′, and the like, and so on for the entire length of the spread, or, alternatively, for regions of the spread. Mathematical functions describing acoustic velocity propagation may fit plots of time vs. range for the entire spread, or for regions of the spread. For example, if the type of mathematical function chosen for the fitting routine is a polynomial, the polynomial may be expressed as one of the following, where R indicates the variable range, and X and Y the cross- and length-wise coordinates in a spread:
V(X, R)=a₀+a₁XR+ . . . +aₙ₋₁Xⁿ⁻¹Rⁿ⁻¹+aₙXⁿRⁿ;
V(X, Y, R)=a₀+a₁XYR+ . . . +aₙ₋₁Xⁿ⁻¹Yⁿ⁻¹Rⁿ⁻¹+aₙXⁿYⁿRⁿ;
V(X, Y, Z, R)=a₀+a₁XR+ . . . +aₙ₋₁Xⁿ⁻¹Yⁿ⁻¹Zⁿ⁻¹Rⁿ⁻¹+aₙXⁿYⁿZⁿRⁿ.
The coefficients may be determined in one step or iteratively, and may employ any known algorithm.

Several examples are now presented for mathematical model of acoustic velocity propagation velocity.

Acoustic propagation velocity estimation based on acoustic range measures.

In this model,
ζ(X)=u·v is the mathematical model, or function of variable vector (X), that describes the measured distance, a two dimensional distance formula multiplied by a scale factor
where
u=(ΔE²+ΔN)^{1/2} is the mathematical model for a computed distance in two dimensions with no scale error
v=scale is multiplied by the mathematical model of two dimensional distance and is one when the signal propagation time is known
υ=Nu radius of curvature along lines of latitude, used to convert radians to meters
ρ=rho radius of curvature along lines of longitude, used to convert radians to meters
λᵢ=latitude at point i
φᵢ=longitude at point i
   φₘ=(φ₁ φ₂)_{/2}
E=Easting and N=Northing
   ΔE=(λ₁−λ₂)υ cos φₘ and ΔN=(φ₁−φ₂)·ρ.

The Misclosure Vector, b

The so-called misclosure vector b, is also a computed observation, derived from a Taylor series that serves to linearize the non-linear function describing D, the distance model. To form b the range model is linearized as follows:

A Taylor series linearization of the function of (X) of the observed or measured distance:
ζ(X)˜ζ(X₀)+ζ(Xₒ)dx+ . . . where the higher order terms are insignificant and ignored;
where;
D=the measured propagation time between the transmitter and receiver, converted to meters by a provisional sound velocity;
ζ(X₀)=the function for D as shown above with provisional values (Xₒ) for uₒ=(ΔEₒ²+ΔNₒ²)^{1/2} the model for a computed distance in two dimensions;
v=scale a multiplier that gives the correct distance;
λᵢ=latitude at point i;
φᵢ=longitude at point i;
ζ′(Xₒ) is the first derivative of the function with respect to the unknown variables in (X), computed using the above provisional values; and
dx is a vector of corrections to the provisional values that results for solving the linear equation set.
Re-arranging:
   D−ζ(X_{O})=ζ′(X)dx
This form gives the familiar Ax=b where;
   ζ′(X)=A
   dx=x
D−ζ(Xₒ)=b which is reformed until the magnitude of dx satisfies an arbitrary convergence limit.

Homogeneous Sound Velocity Model Where Ax=b

This model is the simplest and is recommended for use in most situations. It assumes there is little or no variation of sound velocity over the region occupied by the spread. When scale is constant, scale=c which adds one unknown to the parameters.

With this model, when filling the “A” or “Design” matrix, rows for acoustic range measures will have the same entries for the position coordinate unknowns whether scale is estimated or not. Initially, the provisional scale value will be 1. The unknowns are X^{Transpose}=[ΔE₁ ΔN₁ ΔE₂ ΔN₂ c]. The partial derivatives for each of the unknowns in the X vector are then computed. The iterative method is identical to the one step except the partial with respect to the function that describes scale is made zero, meaning that these scale amplitude coefficients are not treated as unknowns and the dx vector contains no corrections to the scale function.

Linear Variation in Sound Velocity

To allow for linear change in sound velocity over the region of the spread, the following formula describes scale:
scale=aEₘ+bNₘ+c
which adds 2 unknowns to the parameters, giving 3 total scale unknowns. E and N are any two points.

When the estimated values for a, b and c are found, they should be applied to the point midway between the ends of the range:
Eₘ=(E₁+E₂)/2
Nₘ=(N₁+N₂)/2

and the easting (E) and northings (N) are the coordinates on either end of the range measure.

The partial derivatives for filling the Design Matrix are then based on the derivative:
∂D/∂X=u(∂υ/∂x)+υ(∂u/∂X)

where the unknowns are X^{Transpose}=[Δλ₁ Δφ₁ Δλ₂ Δφ₂ a b c].

Second Degree Polynomial

In this model, scale may be defined as:
scale=dE²+fN²+aE+bN+c

which gives 5 additional unknowns as shown in X,
X_{Transpose}=[ΔE₁ ΔN₁ ΔE₂ ΔN₂ a b c d f]

again with the derivation model ∂D/∂X=u(∂υ/∂x)+υ(∂u/∂X). The 9 partial derivatives with respect to the 9 unknowns are then computed.

All the acoustic distance equations in the calculation unit may written in this way. For any function of acoustic propagation velocity, the scale term is just a little different, and the partial derivative is different. Thus the coordinates and additional amplitude coefficient unknowns may all be solved for in Ax=b, not separately.

In an iterative approach, the propagation model parameters can be held constant while the distance measures give corrections to the coordinates. This is followed by an iteration cycle that holds the coordinates fixed and uses the computed distances to adjust the amplitude coefficients of the propagation model. These two steps can repeat until a convergence criteria is satisfied.

In previous industry attempts, such as by Norton Jr., (U.S. Pat. No. 5,497,356) in the context of seabed cables, multi-lateration using direct arrivals of sonar-like pulses were used to relocate receiver drop locations. One disadvantage to that method was the complex calculations needed to handle the hyperbolic trajectories. Another problem was a limitation in range to line-of-sight or about 250 meters, one way. Because large areal surveys extend for many kilometers, that method had severe limitations.

It has been determined that it is now possible, using the highly redundant ranges available using today's streamers employing point receivers, such as available in Q-Technology™ available from WesternGeco LLC, and intrinsic ranging modulated acoustic techniques, to fit even higher order polynomial regression curves of the nominal ranges between transmitter-receiver sets on the travel times of acoustic signals, whether direct or refracted acoustic signals. In this way, the travel times between each transmitter and its near neighbor point receivers (on the same streamer or neighboring streamers) may be plotted against nominal distances, to create a raw regression plot for each transmitter and its near neighbor point receivers, since there are many more point receivers than transmitters. In the spread illustrated in FIG. 2 there are 1690 ranges.

The “nominal range” means the distance between a streamer-mounted broad spectrum transmitter and the nominal location of each point receiver. The nominal ranges may be computed by inversion of the transmitter coordinates and the nominal receiver coordinates by standard surveying methods. By use of a seismic data processing system, which may be a programmed computer, a mathematical function, for example a high-order polynomial regression curve, is fitted to the velocity as a function of x, y, R, and optionally z data. Any well-known statistical processing routine may be used for that purpose. If a polynomial is used, the order of the polynomial is selected as that order which minimizes the residuals about the regression curve on a least squares basis. Outliers, that is random data that grossly depart from the main data sequence, are rejected in the curve-fitting process. Due to excessive shot-generated noise, times received by point receivers near a transmitter may be distorted by unwanted transients such as shot noise. At extreme ranges, where the signal-to-noise ratio is very low, the times may be too noisy to be useful and/or the arrivals may have propagated along refracted paths that are too deep to be of use for geodetic purposes. This may be seen in FIG. 3. Therefore, range data acceptable to the polynomial optionally may be truncated between preselected range limits with the range maxima being designed to confine the wavefield arrivals to those having propagated along selected paths.

From the regression curves, sets of computed ranges may be computed from the sets of times and computed acoustic propagation velocity, resulting in sets of ranges for each transmitter and its receivers: the set of nominal ranges and as many sets of computed ranges necessary to converge the ranges. The velocity trend may be relatively smooth because a very large number of receiver/transmitter range observations are available.

The above computations may be solved repeatedly for each transmitter/receiver region. Unlike previously known methods, apparatus, and systems, the inventive methods, apparatus, and systems reduce or eliminate irregularities of the computed trends due in part to the sparseness of the samples in previous attempts because of the relatively few receivers associated with each individual transmitter in conventional systems, as well as irregularities reflecting local environmental influences on the point receivers. The receiver coordinates are revised by multi-lateration on the basis of the computed ranges whereupon a new polynomial regression is fitted to the newly computed acoustic propagation velocity as a function of x, y, R and optionally z, and the process is repeated until the difference between the previously determined coordinates and the subsequently-determined coordinates converges to a preselected limit such as 0.1 meter. The radial error, dRMS is derived for each revised receiver position by any well-known means. Well-known Kalman filtering may be employed as desired.

The methods, apparatus, and systems of the invention may also be augmented with additional sensors for increased robustness of the system. Such devices are for instance, but not limited to, inclinometers, pressure gauges, compasses and inertial sensors integrated in or placed on streamers 8, and further acoustic measurements provided by transmitters located on buoys or other vessels. Two possible towed marine applications are so-called Over/Under surveys and surveys employing a positioning streamer. In these towed marine applications, acoustic ranging may occur between streamers at different depths (Z dimension), and determining depth other than by acoustics is useful. In certain embodiments of the present invention, it would be useful to employ a depth-measuring unit integrated into or attached to the streamer at regular intervals that does not employ acoustic ranging from a known point, but instead determines depth by measuring pressure. Knowing this component of the three dimensional coordinates will constrain the points that are available for the measurements to fit into a horizontal X-Y plane and thus allow a better estimate of transmitter and receiver positions with less effort than required with acoustics only.

Useful transmitters 19 are those able to transmit acoustic signals lying within a frequency band that receivers (hydrophones) are capable of detecting. The signals may be intercepted by seismic point receivers, which are already located in streamers, or on the streamers or in the gun array cables. By using the existing receivers in the streamers a good spatial resolution along the cable will be obtained.

Point receivers 18 pick up under water acoustic signals, and may be of a combined type that can record both the low frequency seismic signals and the higher frequency signals normally used for positioning purposes, or they can be dedicated to the positioning signals only. Receivers 18 may be built into streamer 8 at known positions or they may be attached to the cable at known intervals so that the exact distance between the receivers is known. Receivers 18 may be part of a system for hydro-acoustic ranging, for example intrinsic ranging by modulated acoustics, as described in U.S. Pat. No. 5,668,775, assigned to WesternGeco LLC, Houston, Tex., which also comprises transmitters that generate the acoustic signal. The transmitters and receivers may be synchronized so that the transmission delay between a transmitter and a receiver can be measured.

Streamers useful in the invention have well-known constructions, and may comprise a large number of similar 100 meter, or different length sections connected end-to-end, each section comprising a substantially cylindrical outer skin containing a pair of longitudinally extending strength members to bear the towing forces. Acoustic transmitters and receivers may be substantially uniformly distributed along the length of the streamer section.

Another streamer construction comprises an elongate substantially solid core, at least one longitudinally extending strength member and a plurality of acoustic transmitters and receivers embedded in the core, a polymeric outer skin surrounding the core and defining there around an annular space, and polymeric foam material adapted to be substantially saturated with liquid and substantially filling the annular space.

Seismic streamers may normally be towed at depths ranging from about 3 to 20 meters below the surface of the water by means of a “lead-in”, a reinforced electro-optical cable via which power and control signals are supplied to the streamer and seismic data signals are transmitted from the streamer back to the vessel, the vertical and/or horizontal position of the streamers being controlled by orientation members, or steerable “birds” distributed along the length of the streamer. Typically, the front end of the streamer is mechanically coupled to the lead-in by at least one vibration-isolating section (or “stretch section”), while the rear end is coupled to a tail buoy incorporating a GPS position measuring system, typically via another “stretch section”. In accordance with one embodiment of the invention, a streamer or spread of streamers may alternately be towed at a variety of depths to obtain some knowledge at those depths. Alternatively, a failed streamer, (failed in the sense that it is disabled and cannot be used for some reason for seismic data acquisition) may be used.

In addition to the mathematical curve fitting techniques, in certain embodiments the calculation unit may apply a vertical correction to all the measured transmission delays so that they correspond to a measurement taken exactly in the longitudinal direction of a streamer. For the best precision this correction should take into account the shape of the sonic rays, for instance using a system such as described in U.S. Pat. No. 6,388,948, which utilizes a device such as a computer or microprocessor for determining the effective sound velocity between underwater points. The following information is used: (i) an estimate of the sound velocity profile from a source of sound energy located at an initial depth to a predetermined final target depth, (ii) a predetermined set of grazing angles, (iii) a predetermined number of target depths between the initial depth and the final target depth, and (iv) a predetermined uniform set of elevation angles. A corresponding elevation angle and an effective sound velocity value is calculated for each grazing angle and target depth. The calculated elevation angles are scanned to locate a pair of calculated elevation angles which correspond to a pair of successive grazing angles and a particular target depth wherein the particular elevation angle of the uniform set is between the pair of calculated elevation angles. The calculated effective sound velocity values corresponding to each elevation angle of the pair of calculated elevation angles are interpolated to produce an interpolated effective sound velocity.

The conventional ways of determining the sound velocity profile are time consuming and cannot in practice be repeated very often. The apparatus, systems, and methods of the invention do not require any stop of operation or alteration of the production procedures as the measurements can be taken automatically. The algorithm for determination of the sound velocity can be programmed into a computer that can calculate it automatically. The process can essentially be run at all times when deploying a towed seismic spread.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. In the claims, no clauses are intended to be in the means-plus-function format allowed by 35 U.S.C. §112, paragraph 6 unless “means for” is explicitly recited together with an associated function. “Means for” clauses are intended to cover the structures described herein as performing the recited function and not only structural equivalents, but also equivalent structures.

1. A method comprising:
a) deploying in a marine environment a towed seismic spread comprising a plurality of acoustic positioning transmitters and a plurality of positioning point receivers; and
b) using travel times for signals between at least some of the transmitters and point receivers to derive a mathematical model describing acoustic propagation velocity for the marine environment as a function of at least one spread spatial dimension, distance between the transmitters and receivers, or any combination of these.

2. The method of claim 1 wherein estimation of unknowns of the mathematical model occurs in one step.

3. The method of claim 2 wherein a set of linear equations is inverted simultaneously, until an arbitrary convergence limit is reached.

4. The method of claim 3 wherein the set of linear equations comprises one or more continuous linear functions of the type:
sv=mx+ny+pz+const
where
“sv” is sound velocity;
“mx+ny” describes the spatial dependence in x and y;
“pz” describes the range length dependency;
“m”, “n”, and “p” are coefficients; and
“const” is the combined intercept value for the three linear terms.

5. The method of claim 1 wherein the mathematical model comprises mathematic functions selected from polynomials and splines.

6. The method of claim 1 wherein variation of the acoustic propagation velocity with horizontal separation distance between transmitters and receivers is accounted for in the estimate.

7. The method of claim 1 wherein one or more of the transmitters emit encoded transmissions, and the derivation of the mathematical model comprises fitting a mathematical function to a set of time versus range data in a selected dimension to estimate the acoustic propagation velocity as a function of position of the receivers in the selected dimension, the set of data comprising measured time differences between transmission and reception at each receiver of encoded acoustic signals from the one or more encoded transmitters.

8. The method of claim 1 wherein one or more of the transmitters emit encoded transmissions, and step b) comprises generating and transmitting different orthogonally encoded spread spectrum signals from the plurality of acoustic positioning transmitters, the spread spectrum signals having a prominent peak in an autocorrelation function thereof.

9. The method of claim 8 comprising detecting the spread spectrum signals using the plurality of acoustic point receivers positioned at nominal locations, the receivers being in communication with a calculation unit.

10. The method of claim 9 comprising defining at least one set of nominal or provisional distances between each of the plurality of acoustic positioning transmitters and each point receiver.

11. The method of claim 10 comprising measuring one or more sets of times for reception of a first set of spread spectrum signals at the receivers for each set of nominal or provisional distances, and with the aid of the calculation unit, calculating nominal acoustic propagation velocity as a function of the nominal or provisional distances, the times for reception of the signals, and at least one dimension of the point receivers.

12. The method of claim 11 comprising measuring one or more sets of times for reception of a second set of spread spectrum signals at the point receivers, and multiplying the calculated nominal acoustic propagation velocities by the times for reception of the second set of spread spectrum signals to calculate estimated ranges.

13. The method of claim 12 comprising measuring one or more sets of times for reception of a third set of spread spectrum signals at the point receivers and recalculating acoustic propagation velocity as a function of estimated ranges, time for reception of the third set of signals, and at least one coordinate point of the point receivers.

14. The method of claim 13 comprising iteratively calculating differences until the difference between a new repositioned receiver location and a previously-defined receiver location converges to within a predefined limit.

15. The method of claim 1 wherein the transmitters generate spread spectrum signals at a frequency ranging from about 500 to about 4000 Hz.

16. An apparatus comprising:
(a) a towed streamer marine seismic spread comprising a plurality of acoustic positioning transmitters and a plurality of acoustic positioning receivers, the transmitters and receivers communicating with a calculation unit;
(b) the calculation unit using travel times for signals between at least some of the transmitters and receivers to derive a mathematical model describing acoustic propagation velocity for a marine environment as a function of at least one spread spatial dimension, distances between the transmitters and receivers, and any combination thereof.

17. The apparatus of claim 16 wherein the mathematic model comprises one or more continuous linear functions of the type:
sv=mx+ny+pz+const
where
“sv” is sound velocity;
“mx+ny” describes the spatial dependence in x and y;
“pz” describes the range length dependency;
“m”, “n”, and “p” are coefficients; and
“const” is the combined intercept value for the three linear terms.

18. The apparatus of claim 16 wherein the mathematical model includes one or more polynomials having degree of 1 or higher.

19. The apparatus of claim 16 wherein the mathematical function is 2- or 3-dimensional function.

20. A system comprising:
(a) a tow vessel;
(b) a towed streamer marine seismic spread towed by the tow vessel, the spread comprising a plurality of acoustic positioning transmitters and a plurality of acoustic positioning receivers, the transmitters and receivers communicating with a calculation unit;
(c) the calculation unit using travel times for signals between at least some of the transmitters and receivers to derive a mathematical model describing acoustic propagation velocity for a marine environment as a function of at least one spread spatial dimension, distances between transmitters and receivers, and any combination of these.
